(19) United States
(12) Patent Application Publication
(10) Pub. No.: US 2026/0142848 A1
(43) Pub. Date: May 21, 2026

(54) BORDER GATEWAY PROTOCOL (BGP) COLOR-AWARE ROUTING POINT-TO-MULTIPOINT (P2MP) TECHNIQUES

(71) Applicant: Cisco Technology, Inc., San Jose, CA (US)

(72) Inventors: Mankamana P. Mishra, San Jose, CA (US); Swadesh Agrawal, San Jose, CA (US); Zafar Ali, Hicksville, NY (US)

(21) Appl. No.: 19/191,656

(22) Filed: Apr. 28, 2025

Related U.S. Application Data
(60) Provisional application No. 63/722,389, filed on Nov. 19, 2024.

(51) Int. Cl. H04L 12/18; H04L 12/46; H04L 45/16

(52) U.S. Cl. CPC H04L 12/185; H04L 12/4633; H04L 45/16

(57) ABSTRACT

Provided herein are techniques to facilitate Border Gateway Protocol (BGP) color-aware routing (CAR) Point-to-Multipoint (P2MP) optimizations. In at least one embodiment, a method may include obtaining a plurality of BGP join requests, each BGP join request being obtained from a corresponding receiver node requesting to join a multicast group and receive traffic provided by the source node, wherein each BGP join request identifies a corresponding intent representing a corresponding level of service for routing the traffic to each corresponding receiver node. The method may further include identifying a highest-ranking intent from among the BGP join requests and transmitting another BGP join request to the source node that includes the highest-ranking intent. The method may further include, upon obtaining traffic from the source node, routing the traffic to each corresponding receiver node according to the corresponding intent associated with each receiver node.

### PRIORITY CLAIM

This application claims the benefit of priority under 35 U.S.C. § 119 to U.S. Provisional Application No. 63/722,389, filed Nov. 19, 2024, the entirety of which is incorporated herein by reference.

### TECHNICAL FIELD

The present disclosure relates to network equipment and services.

### BACKGROUND

Color-aware routing (CAR) is a Border Gateway Protocol (BGP)-based routing solution that can be used to establish end-to-end intent-aware paths across a multi-domain transport network, which can span multiple service provider and/or network domains. In BGP CAR, intent-aware paths can be used to steer traffic across service routes that are associated with a specific intent. However, in current BGP CAR implementations when multiple receivers subscribe to receive the same traffic, with each receiver expressing a different intent in their respective subscription request to receive the traffic, a new routing tree is created for each receiver, leading to multiple routing trees for routing the traffic to the receivers, which can lead to a waste of network resources.

### BRIEF DESCRIPTION OF THE DRAWINGS

FIG. 1 is a block diagram illustrating issues with current Border Gateway Protocol (BGP) color-aware routing (CAR) deployments in which multiple receivers each originate requests to receive the same traffic with different intents.

FIG. 2A is a block diagram of a system that may be implemented to facilitate Border Gateway Protocol (BGP) color-aware routing Point-to-Multipoint (P2MP) techniques for a network, according to an example embodiment.

FIG. 2B is a schematic diagram illustrating example details associated with a multicast routing information base (MRIB) maintained for the system of FIG. 2A, according to an example embodiment.

FIG. 2C is a block diagram data plane traffic routing details for the system of FIG. 2A, according to an example embodiment.

FIG. 3A is a block diagram illustrating example operations for a first case for handling membership leave for the system of FIG. 2A, according to an example embodiment.

FIG. 3B is a block diagram illustrating example operations for a second case for handling membership leave for the system of FIG. 2A, according to an example embodiment.

FIG. 4 is a flow chart depicting a method according to an example embodiment.

FIG. 5 is a flow chart depicting a method according to an example embodiment.

FIG. 6 illustrates a hardware block diagram of a computing device configured to perform functions associated with operations discussed in connection with embodiments herein.

### DETAILED DESCRIPTION

### Overview

Embodiments herein address aspects of multicast routing and associated optimizations/techniques. In various embodiments, an apparatus, a system, method, and/or a non-transitory computer-readable storage medium may be provided to facilitate Border Gateway Protocol (BGP) color-aware routing Point-to-Multipoint (P2MP) optimizations/techniques. In at least one instance, embodiments herein may define optimal techniques to build a routing tree for a color-aware network involving multiple receivers subscribed with different intents to receive the same traffic.

In at least one embodiment, a method may be provided that is performed by a boundary router that interfaces with a source node of a first service provider and each of a corresponding receiver node of a plurality of receiver nodes of other different service providers. The method may include obtaining (by the boundary router) a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node; identifying a highest-ranking intent from among the plurality of BGP join requests; transmitting another BGP join request to the source node for the multicast group that includes the highest-ranking intent; and upon obtaining traffic from the source node for the multicast group via a tunnel that satisfies the highest-ranking intent, routing the traffic to each corresponding receiver node according to the corresponding intent associated with each corresponding receiver node.

### Example Embodiments

Color-aware routing (CAR), as defined in International Engineering Task Force (IETF) Request for Comments (RFC) draft-ietf-idr-bgp-car-13, published February 2025, is a BGP-based routing solution that can be to establish end-to-end intent-aware paths across a multi-domain transport network, which can span multiple service provider and/or network domains. In BGP CAR, intent-aware paths can be used to steer traffic across service routes that are associated with a specific network intent or intent. Current solutions for CAR BGP primarily focus on unicast implementations of the BGP CAR technology.

In a network, a ‘network intent’ or ‘intent’ can be defined by some characteristics for a given flow. Stated differently, an intent can define the type/level of service class for which an end user/administrator, or more generally, a ‘receiver node’ or ‘receiver’, seeks to receive traffic, such as:
Low latency
Low Jitter
High Bandwidth path
Low Cost
Best Effort

Other characteristics can, of course, be envisioned. Generally, an intent identified by a receiver can be used to establish a tunnel having a level of service that meets the identified intent in order to deliver traffic/content to the receiver for the corresponding level of service.

At present, a multicast implementation is defined in which there is a source behind one service provider and there are multiple other service providers or domains at which receivers (e.g., receiving nodes) are present that subscribe to receive traffic from the source. In one example, there can be three other service providers or domains where receivers are present in which each respective receiver's network originates a respective membership request toward the source to receive the same traffic/content, with each respective membership request expressing/identifying a different intent for the level of service that is to be provided for delivering traffic to each respective receiver (e.g., via a respective tunnel for each receiver).

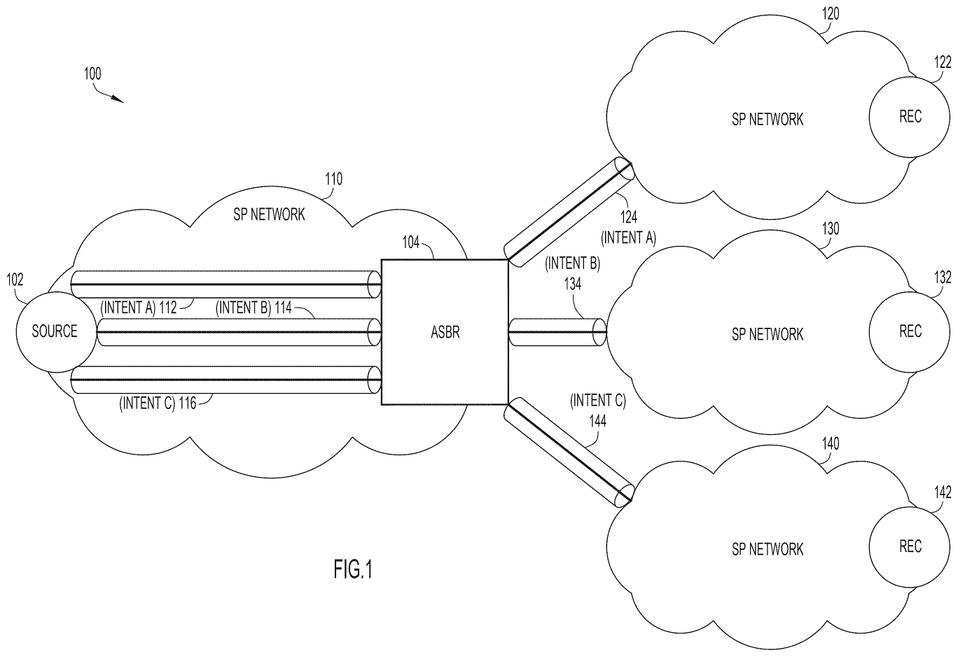

With reference to FIG. 1, FIG. 1 is a block diagram 100 illustrating issues with current BGP CAR deployments in which multiple receivers each originate BGP join requests for a multicast group to receive the same traffic with different intents. FIG. 1 includes a service provider (SP) network 110 that includes a source node or, more generally, a source 102 that interfaces with an Asynchronous System Boundary Router (ASBR) 104. The ASBR 104 can further interface with a number of other SP networks and receiver nodes (more generally, receivers), such as an SP network 120 including a receiver node or, more generally, a receiver 122, an SP network 130 including a receiver 132, and an SP network 140 including a receiver 142.

For FIG. 1, consider that receiver 122 sends a BGP join request to ASBR 104 to join a multicast group {S, G} in which ‘S’ identifies source 202 and ‘G’ indicates a corresponding multicast group identifier (ID), that includes an intent ‘A’ requesting content/traffic to be received from source 102 (via ASBR 104), which triggers establishment of a tunnel 124 between ASBR 104 and SP network 120/receiver 122 that is to provide a first level of service ‘A’ (e.g., low latency). Further, consider that receiver 132 sends a BGP join request to ASBR 104 to join the same multicast group {S, G} that includes an intent ‘B’ requesting content/traffic to be received from source 102, which triggers establishment of a tunnel 134 between ASBR 104 and SP network 130/receiver 132 that provides a second level of service ‘B’ (e.g., high bandwidth). Additionally, consider that receiver 142 sends a BGP join request to ASBR 104 to join the same multicast group {S, G} that includes an intent ‘C’ requesting content/traffic to be received from source(S) 102, which triggers establishment of a tunnel 144 between ASBR 104 and SP network 140/receiver 142 that provides a third level of service ‘C’ (e.g., low cost).

Per “draft-ietf-idr-bgp-car-13,” each of a given intent can be identified using a 32-bit numerical value. Thus, different 32-bit numerical values can be associated with multiple different network intents for a given deployment. For example, different 32-bit numerical values can be associated with intent ‘A’, intent ‘B’, and intent ‘C’.

With reference to FIG. 1, even though the same content is being subscribed to by the different receivers 122, 132, and 142, since each of their intents is different, three different routing trees would be created to the source 102. More specifically, a tunnel 112 that provides the first level of service for intent ‘A’ would be created for delivering the content to receiver 122, another tunnel 114 that provides the second level of service for intent ‘B’ would be created for delivering the same content to receiver 132, and yet another tunnel 116 would be created that provides the third level of service for intent ‘C’ for delivering the same content to receiver 142.

This approach can create multiple problems, such as:
The host network, where the multicast source is present (e.g., source 102), forwards the same content multiple times.
Each byte of traffic has an associated cost. Multiple copies of traffic going over the same network increases operational costs for the operator.
For a video stream, as video stream bandwidth is increasing day by day due to video quality, more load is added on the network.

As intent aware network adoption continues to increase, embodiments herein define techniques that can facilitate optimizations for a network in order to prevent multiple copies of traffic from being flowed in the network for a multicast group. More generally, such optimizations as provided through embodiments herein can be characterized as Point-to-Multipoint (P2MP) optimizations, for example, optimizations for delivering traffic/content from a first point, or source, to multiple other points, or receivers, for a multicast group.

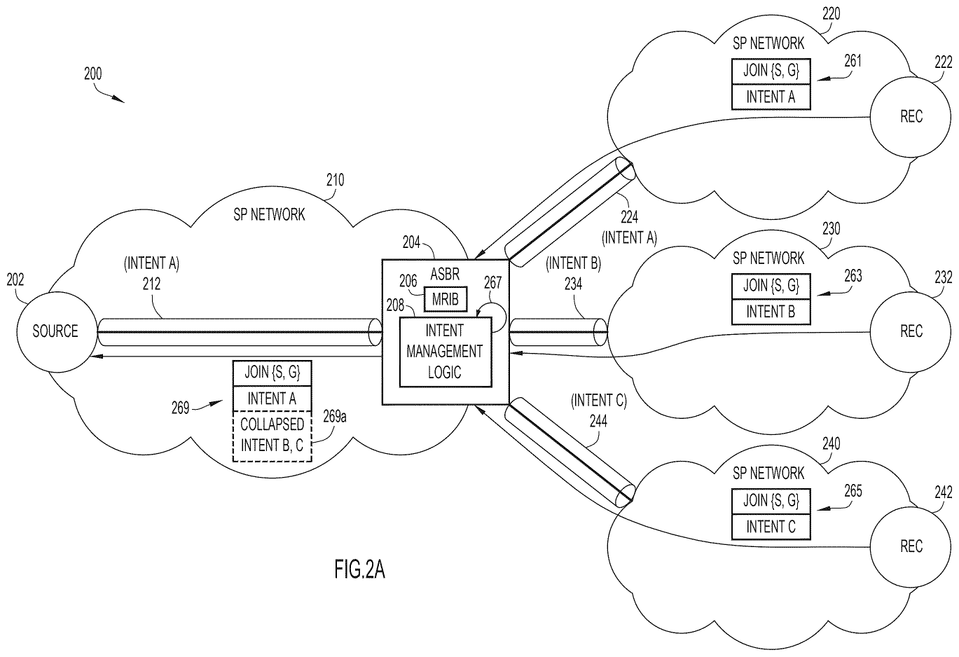

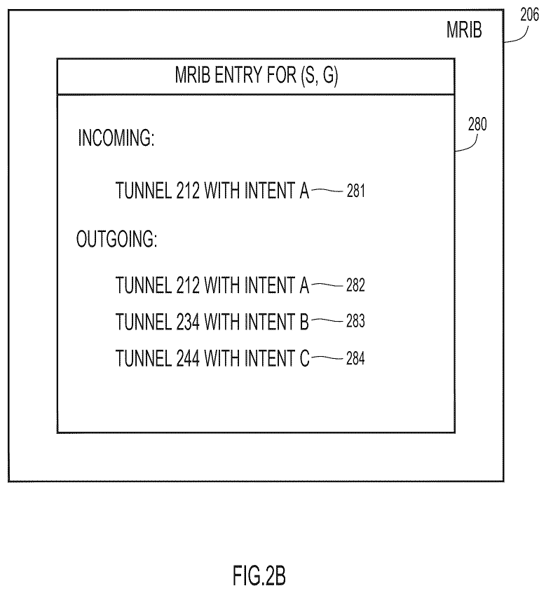

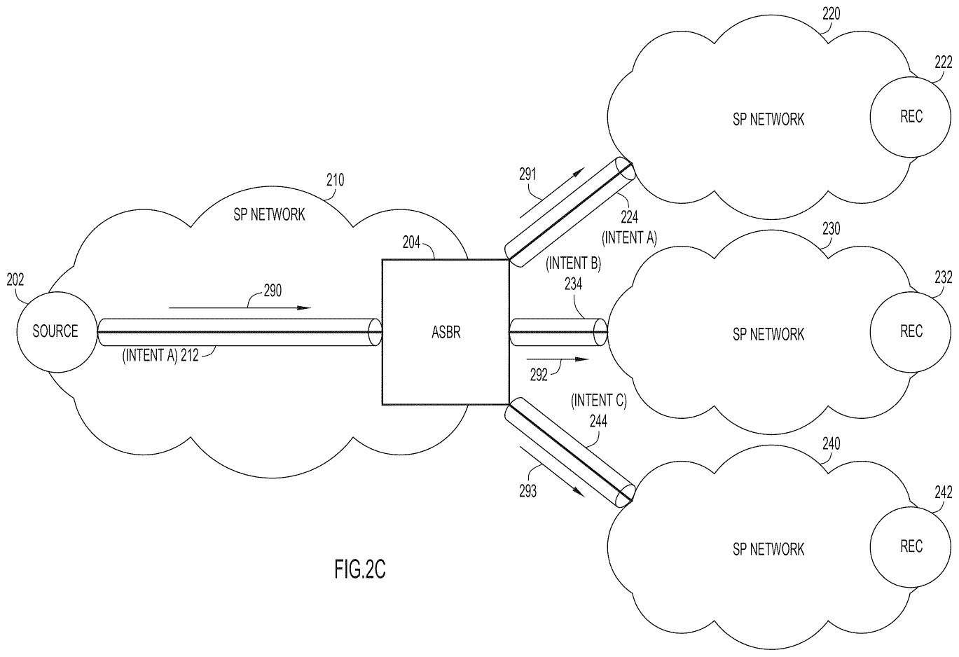

With reference to FIG. 2A, FIG. 2A is a block diagram of a system 200 that may be implemented to facilitate BGP color-aware routing (CAR) P2MP techniques, according to an example embodiment. Broadly, embodiments of the techniques provided herein address aspects of multicast routing and associated optimizations.

FIG. 2A includes an SP network 210 that includes a source node or, more generally, a source 202 that interfaces with an ASBR 204 in which ASBR 204 is configured to store one or more multicast routing information base (MRIB) entries in a MRIB, such as within an MRIB 206. The ASBR 204 can store routing information for routing/forwarding traffic from a given source to receivers for each of one or more multicast groups supported by the ASBR 204 within one or more MRIB entries maintained/managed by the ASBR 204. In at least one embodiment, the MRIB 206 may be configured remote to the ASBR 204 (e.g., via a network controller, database, or the like) but may be accessible by the ASBR 204. The ASBR 204 can further be configured with intent management logic 208 that can be configured to perform various operations discussed herein in order to facilitate the BGP CAR P2MP optimizations as provided by embodiments herein.

The ASBR 104 can further interface with a number of other SP networks/domains and receiver nodes (more generally, receivers), such as an SP network 220 including a receiver node or, more generally, a receiver 222, an SP network 230 including a receiver 232, and an SP network 240 including a receiver 242. Each of SP network 220, SP network 230, and SP network 240 can be characterized as a different Autonomous System (AS).

Embodiments of the techniques provided herein may include various components, such as:
Collapsing intent at a merge point, such as, for example, at ASBR 204;
Creating a single routing tree based on the collapsed intent;
Data plane handling; and
Handling migration from one intent to another intent (e.g., for scenarios in which one or more receivers may join and/or leave a given multicast group).

In order to illustrate various features of embodiments herein, consider an operational example with reference to FIG. 2A through which various operations associated with control plane collapsing of intent at a merge point can be performed.

In at least one instance, embodiments herein assume that intent expressed by multiple receivers seeking to join a given multicast group can be put in an ordered list at a merge point, such as at ASBR 204.

For example, with reference to FIG. 2A, embodiments herein may facilitate handling multicast group membership requests such that, upon defining intents for a given deployment that are agreed on by each of multiple service providers for the deployment (e.g., through a common agreement among all providers), an intent ranking can be configured for the merge point (e.g., ASBR 204) that can be used by the merge point to evaluate intents associated with each of multiple BGP join requests received for subscribing to a given multicast group.

In at least one embodiment, an intent ranking can be configured for ASBR 204, such as: intent A>intent B>intent C> . . . >intent ‘X’ (for an ‘X’ number of intents) in which Intent A is considered to be the most premium or highest level of service for the deployment that all of the providers (e.g., the provider for SP network 210, the provider for SP network 220, the provider for SP network 230, and the provider for SP network 240) have agreed to for intent ranking for the deployment. In at least one embodiment, a controller (not shown), such as a network controller, a network management system or the like may configure, update, or otherwise manage an intent ranking for one or more merge points (e.g., ASBR(s)) of a network.

As illustrated via FIG. 2A, consider that ASBR 204 obtains a BGP join request 261 from SP network 220/receiver 222 to join a multicast group {S, G} in order to receiver traffic/content to be provided by source 202 in which the BGP join request 261 identifies an intent A for the level of service for which the receiver 222 seeks to receive the traffic provided by source 202. Obtaining the BGP join request 261 triggers establishment of a tunnel 224 between ASBR 204 and SP network 220/receiver 222 that meets the level of service corresponding to intent A. Tunnel 224 establishment can be performed in accordance with “draft-ietf-idr-bgp-car-13.”

Consider that ASBR 204 further obtains a BGP join request 263 from SP network 230/receiver 232 to join the same multicast group {S, G} in order to receiver traffic/content to be provided by source 202 in which the BGP join request 263 identifies an intent B for the level of service for which the receiver 232 seeks to receive the traffic provided by source 202, which triggers establishment of a tunnel 234 between ASBR 204 and SP network 230/receiver 232 that meets the level of service corresponding to intent B. Finally, consider that ASBR 204 further obtains a BGP join request 265 from SP network 240/receiver 242 to join the same multicast group {S, G} in order to receiver traffic/content to be provided by source 202 in which the BGP join request 265 identifies an intent C for the level of service for which the receiver 242 seeks to receive the traffic provided by source 202, which triggers establishment of a tunnel 244 between ASBR 204 and SP network 240/receiver 242 that meets the level of service corresponding to intent C.

Thus, the ASBR 204 can obtain BGP join requests from different autonomous systems, each being received with different intents. It is to be understood that the order of obtaining the BGP join requests may occur in any order. Further, it is to be understood that the BGP join requests 261, 263, and 265 do not illustrate the actual encodings of each request, but rather high-level details of BGP join fields associated with embodiments herein that can be used to carry color/intent.

As generally illustrated at 267, based on the prior-define agreement among the providers regarding the intent ranking (e.g., intent A>intent B>intent C> . . . >intent ‘X’) configured for ASBR 204, the ASBR 204, via intent management logic 208 can identify a highest-ranking color or intent (e.g., a highest priority or level of service) from among the colors/intents identified in each of the BGP join requests 261, 263, and 265. In this example, intent A identified by BGP join request 261 would be identified as the highest-ranking intent from among the BGP join requests 261, 263, and 265.

Upon identifying the highest-ranking intent, the ASBR 204, via intent management logic 267, generates one BGP join request 269 towards the source 202 for the multicast group {S, G} in accordance with embodiments herein. In at least one embodiment, the BGP join request 269 includes the identified highest-ranking intent, intent A in this example, which triggers establishment of a tunnel 212 between ASBR 204 and source 202 that meets or satisfies the level of service corresponding to the identified highest-ranking, intent A in this example.

In some embodiments, the BGP join request 269 can be generated to include a collapsed intent field 269a, which carries or identifies the lower ranking intents, referred to herein as ‘collapsed intent’ from among the obtained BGP join requests 261, 263, and 265; intent B and intent C in this example. The collapsed intent can be identified in the BGP join request 269 sent to the source 202 for operational and/or monitoring purposes. For example, customers associated with SP network 230 and SP network 240 may desire to see the full routing tree to the source 202 for monitoring purposes. Sending collapsed intent to the source 202 can facilitate such monitoring as the source 202 can store each of the different intents associated with the multicast group {S, G}.

Upon establishment of the tunnels 224, 234, 244, and 212, ASBR 204, via intent management logic 208, can update the MRIB 206 with identifying information regarding each tunnel and its corresponding level of service for the multicast group {S, G} membership, as generally shown in FIG. 2B. For example, as shown in FIG. 2B, the MRIB 206 can be updated to include an entry 280 for the multicast group {S, G} that identifies tunnel 212 with intent A as the tunnel through which the incoming traffic from source 202 will be received, as shown at 281. Further, the MRIB entry 280 for the multicast group {S, G} can be updated to identify tunnel 224 with intent A as the tunnel through which outgoing traffic for the multicast group will be routed to SP network 220/receiver 222, as shown at 282. The MRIB entry 280 for the multicast group {S, G} can also be updated to identify tunnel 234 with intent B as the tunnel through which outgoing traffic for the multicast group will be routed to SP network 230/receiver 232, as shown at 283. Finally, the MRIB entry 280 for the multicast group {S, G} can be updated to identify tunnel 244 with intent B as the tunnel through which outgoing traffic for the multicast group will be routed to SP network 240/receiver 242, as shown at 284. Accordingly, the MRIB entry 280 can represent a routing tree for the multicast group {S, G}.

Forwarding/data plane logic (not shown) for the ASBR 204 can be programmed/configured to facilitate traffic routing/data flow for the multicast group {S, G}, as generally illustrated at 290, 291, 292, and 293, in FIG. 2C, in accordance with the MRIB entry 280 for the multicast group {S, G} illustrated in FIG. 2B, per the corresponding intent identified by each of the corresponding receivers 222, 232, and 242 per their corresponding BGP join requests 261, 263, and 265.

Accordingly, embodiments herein may facilitate the creation of a single multicast routing tree from source 202 to ASBR 204, and then to each of SP network 220/receiver 222, SP network 230/receiver 232, and SP network 240/receiver 242 to facilitate a P2MP optimization for BGP CAR implementations over current solutions.

In some instances, a receiver for a multicast group may seek to leave the group. Membership leave can be handled through two cases in accordance with embodiments herein.

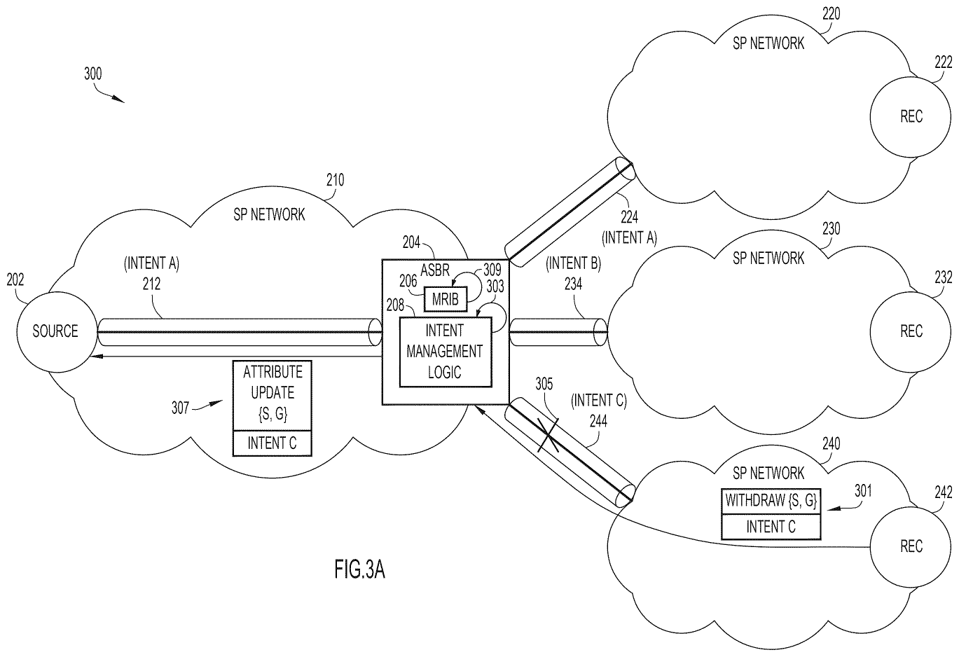

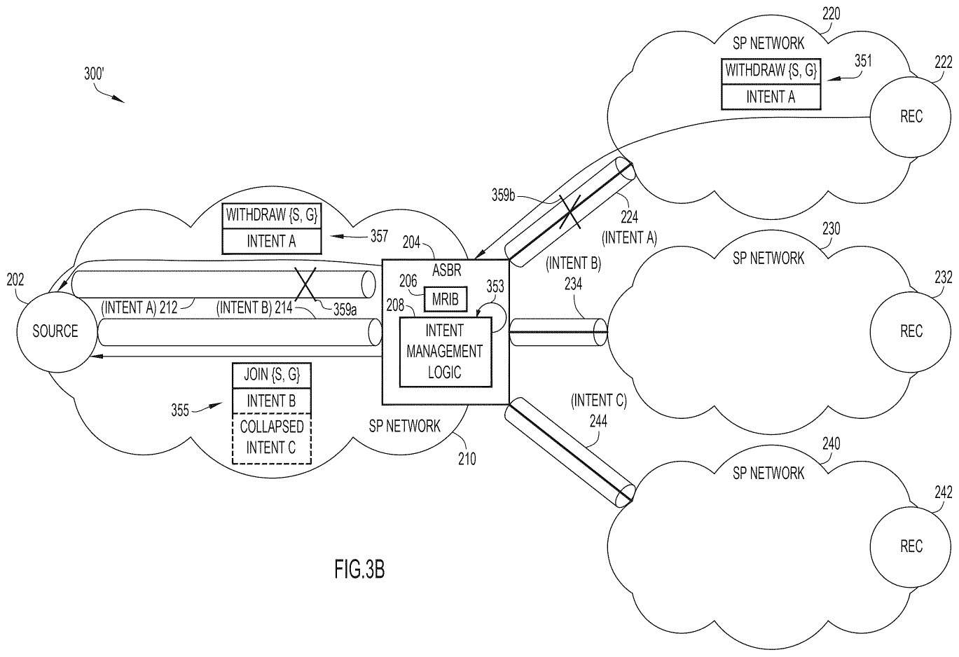

For example, FIG. 3A is a block diagram 300 illustrating example operations for a first case for handling membership leave for the system of FIG. 2A, according to an example embodiment.

The first case for handling multicast group membership leave involves a scenario in which the intent associated with the receiver from which a membership withdraw request has been received is not associated with the highest-ranking priority for a given multicast group. For example, consider a scenario as illustrated in FIG. 3A in which receiver 242 associated with intent C in for the multicast group {S, G} sends a BGP withdraw for the multicast group {S, G} to ASBR 204, as shown at 301, that identifies the intent C associated with the receiver 242.

Upon receiving the BGP withdraw, ASBR 204, via intent management logic 208, MRIB 206/MRIB entry 280, and the configured intent ranking can determine that the intent associated with receiver 242 (intent C) is not the highest-ranking intent for the multicast group {S, G}, as generally shown at 303.

In the case of a receiver not associated with the highest-ranking intent for a multicast group seeking to leave the multicast group, the ASBR 204 can terminate the tree towards the lower-ranking receiver, for example, terminating the tunnel 244 toward SP network 240/receiver 242 to stop routing the traffic to the SP network 240/receiver 242, as generally shown at 305.

The ASBR 204 can also send a BGP attribute update to the source removing intent C from the list of intents stored by the source 202 for the multicast group {S, G}, as generally shown 307, and can update the MRIB entry 280 to remove reference to the outgoing tunnel 244 from the MRIB entry 280 for the multicast group {S, G} to stop routing the traffic to the SP network 240/receiver 242, as shown at 309.

With reference to FIG. 3B, FIG. 3B is a block diagram 300′ illustrating example operations for a second case for handling membership leave for the system of FIG. 2A, according to an example embodiment.

The second case for handling multicast membership leave involves a scenario in which the intent associated with the receiver from which a membership withdraw request has been received is associated with the highest-ranking intent for a given multicast group.

For example, consider a scenario in which receiver 222 associated with intent A for the multicast group {S, G} sends a BGP withdraw for the multicast group {S, G} to ASBR 204, as shown at 351 that identifies the intent A associated with the receiver 222. Upon receiving the BGP withdraw, ASBR 204, via intent management logic 208, MRIB 206/MRIB entry 280, and the configured intent ranking can determine that the intent associated with receiver 222 (intent A) is the highest-ranking intent for the multicast group {S, G}, as generally shown at 353.

For instances in which a member of a multicast group that is associated with the highest-ranking intent seeks to withdraw from the group, it may not be desirable to pull the traffic from the source using the highest-ranking intent, as pulling the traffic from the source using the highest-ranking intent may be costly. However, it may also not be desirable to have a service interruption to other receivers of the multicast group in this scenario. Thus, in this scenario, the ASBR 204 can (e.g., at 353) also identify the next highest-level ranking for the multicast group, intent B in the above example, and can originate a new BGP join request towards the source 202 for the multicast group {S, G} that identifies at least intent B (and potentially also intent C as the new collapsed intent), as generally shown at 355, in order to perform a make-before-break operation such that a new tunnel 214 that satisfies the level of service associated with intent B can be established between the source 202 and the ASBR 204 for continuing to stream the traffic to each of SP network 230/receiver 232 and SP network 240/receiver 242 to achieve zero traffic loss. The MRIB 206 can also be updated to include a new MRIB entry (not shown) for the new routing tree involving tunnel 214 and outgoing tunnels 234 and 244 for the multicast routing group {S, G} associated with the new (incoming) tunnel 214 associated with intent B.

Following establishment of the new routing tree and transmission of the traffic from source 202 to SP network 230/receiver 232 and SP network 240/receiver 242, the ASBR 204 can transmit a BGP withdraw for the multicast group {S, G} identifying intent A to the source 202, as generally shown at 357, in order to terminate the previous routing tree (including tunnel 212 and tunnel 224) associated with the previous highest-ranking intent, intent A, as generally shown at 359a and 359b, and can update the MRIB 206 to remove the MRIB entry 280.

Embodiments herein may also facilitate various operations at the merge point (e.g., ASBR 204) for handling new membership requests following establishment of a given routing tree for a given multicast group.

Similar to handling membership leave for a multicast group, there are two cases through which new membership requests can be handled in accordance with embodiments herein.

For example, a first case for handling a new membership request may involve a scenario in which a request to join an existing multicast group identifies an intent that has a lower priority/ranking than the highest-ranking priority for the existing tree for the multicast group. In this scenario, the merge point can create another OIF (Outbound Interface Filter rule) without creating a new tree toward the source.

For example, for a scenario involving the system of FIG. 2A, following creation of the routing tree involving intents A, B, and C, consider that a new receiver seeks to join the multicast routing group {S, G} and sends a BGP join request for the multicast routing group indicating an intent D, where intent A>intent D (in terms of service level agreement), the ASBR 204 can add another OIF to the MRIB entry 280 that identifies a new outgoing tunnel associated with the new receiver for which the traffic from source 202 is to be additionally routed, without creating a new routing tree toward the source 202.

In another example, a second case for handling a new membership request may involve a scenario in which a request to join an existing multicast group identifies an intent that has a higher priority/ranking than the highest-ranking intent for the multicast group. In this scenario, the merge point can create a new multicast routing tree toward the source and the traffic can be switched to the new tree, similar to the make-before-break mechanism discussed for FIG. 3B, in order to route the traffic to from the source to the merge point via a new tunnel satisfying the new highest-ranking intent and thereafter to each of the receivers of the multicast group and then terminating the previous routing tree.

There may be cases where a particular receiver explicitly wants to create a double tree end-to-end. In such a scenario, an overlay BGP join request sent from the receiver can be enhanced to carry extra information, such as in the form of a bit or other extension in the join (e.g., via an extension to the C-Multicast Route join format of Section 4.6 of RFC 6514) that indicates to not merge the trees for the multiple BGP join requests for a given multicast group obtained from the receiver.

Application of embodiments herein may be useful in video traffic use cases. For example, new video traffic with 8K quality will be bigger in size, and having multiple trees for the same content adds extra overhead for customers.

Accordingly, embodiments herein may provide the ability to provision optimal multicast tree building for a multidomain multicast deployment in which a color-aware network is implemented. In some embodiments, a multicast overlay join extension can be used to merge and carry extra information, such as collapsed intent, an indication to not merge trees, etc. Further embodiments herein may facilitate handling for multicast BGP CAR that can be performed at a merge point, such as an ASBR, in the control plane and the data plane. Still further, embodiments herein may support migration between different domains sending BGP join and leave (withdraw) requests with different intents.

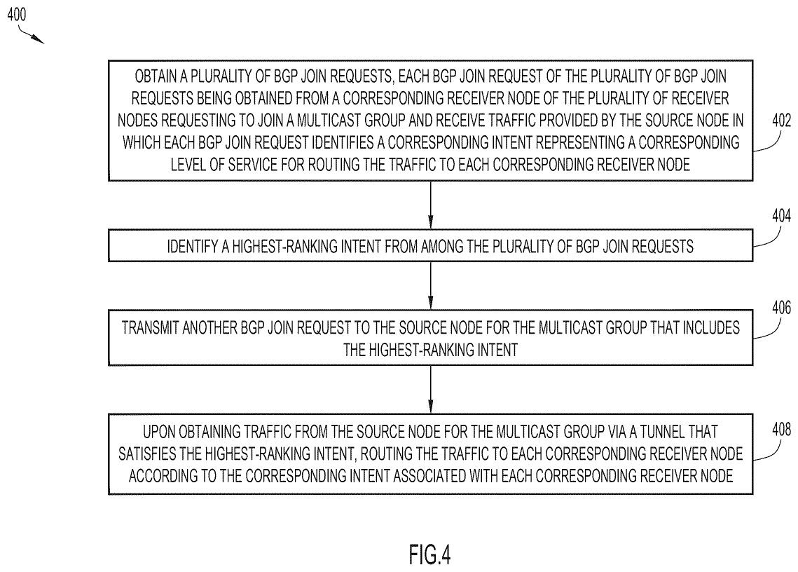

Referring to FIG. 4, FIG. 4 is a flow chart depicting a method 400 according to an example embodiment. In at least one embodiment, method 400 may be performed by a merge point of a service provider network or domain that interfaces a source node with multiple autonomous systems (e.g., multiple receivers of the multiple AS), such as ASBR 204, in order to facilitate the BGP CAR P2MP optimizations as discussed herein. Accordingly, in at least one embodiment, method 400 may be performed by boundary router that interfaces with a source node of a first service provider and each of a corresponding receiver node of a plurality of receiver nodes of other different service providers. In various embodiments, an intent ranking can be configured for or obtained by the boundary router (e.g., from a policy server or the like) in which an order of the intent ranking is agreed upon by the first service provider and the other different service providers.

As shown at 402, the method may include obtaining (by the boundary router) a plurality of BGP join requests, each BGP join request of the plurality of BGP join requests being obtained from a corresponding receiver node of the plurality of receiver nodes requesting to join a multicast group and receive traffic provided by the source node in which each BGP join request identifies a corresponding intent representing a corresponding level of service for routing the traffic to each corresponding receiver node.

As shown at 404, the method may include identifying a highest-ranking intent from among the plurality of BGP join requests. The identifying can be performed based on the intent ranking configured for or obtained by the border router.

As shown at 406, the method may include transmitting another BGP join request to the source node for the multicast group that includes the highest-ranking intent. Although not shown in FIG. 4, the method may further include maintaining a MRIB by the boundary router that includes an entry for the multicast group that identifies a tunnel through which traffic is to be received from the source node and identifies each of a corresponding tunnel and the corresponding level of intent associated with each corresponding receiver node.

As shown at 408, the method may include, upon obtaining traffic from the source node for the multicast group via a tunnel that satisfies the highest-ranking intent, routing the traffic to each corresponding receiver node according to the corresponding intent associated with each corresponding receiver node.

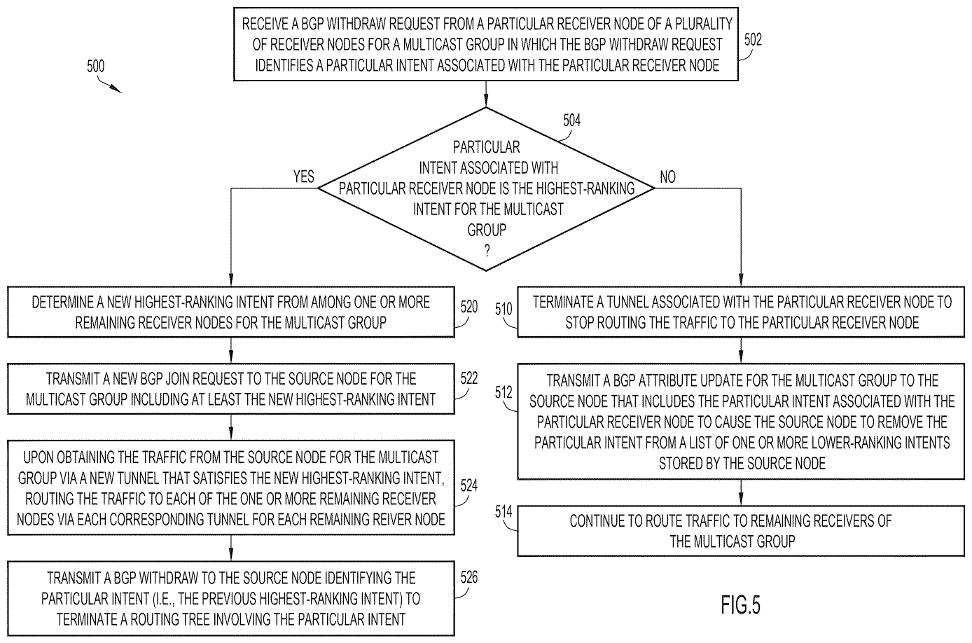

Referring to FIG. 5, FIG. 5 is a flow chart depicting another method 500 according to an example embodiment. In at least one embodiment, method 500 may be performed by a merge point of a service provider network or domain that interfaces a source node with multiple autonomous systems (e.g., multiple receivers of the multiple AS), such as ASBR 204, in order to handle requests to leave a multicast group for different facilitate the BGP CAR scenarios, as discussed herein.

As shown at 502, the method may include receiving (by the boundary router) a BGP withdraw request from a particular receiver node of a plurality of receiver nodes for a multicast group in which the BGP withdraw request identifies a particular intent associated with the particular receiver node.

At 504, the method may include determining whether the particular intent associated with particular receiver node is the highest-ranking intent for the multicast group. In at least one embodiment, the determining at 504 can be performed based on an intent ranking configured for or obtained by the boundary router and an MRIB entry maintained for the multicast group that identifies each of the intents associated with each of the tunnels established for each of the receivers of the multicast group.

As shown at 510, upon determining that the particular intent is not the highest-ranking intent (NO at 504), the method may include terminating (removing, deleting, etc.) a tunnel associated with the particular receiver node to stop routing the traffic to the particular receiver node. As shown at 512, the method may further include transmitting a BGP attribute update for the multicast group to the source node that includes the particular intent associated with the particular receiver node to cause the source node to remove the particular intent from a list of one or more lower-ranking intents stored by the source node. As shown at 514, the boundary router can continue to route traffic to the remaining receivers of the multicast group.

Returning to 504, upon determining that the particular intent is the highest-ranking intent (YES at 504), the method may include determining a new highest-ranking intent from among one or more remaining receiver nodes for the multicast group, as shown at 520.

Upon determining the new highest-ranking intent, the method may include transmitting a new BGP join request to the source node for the multicast group including at least the new highest-ranking intent, as shown at 522. In at least one embodiment, the BGP join can also include collapsed intent identifying one or more lower-ranking intents for the multicast group.

As shown at 524, the method may include, upon obtaining the traffic from the source node for the multicast group via a new tunnel that satisfies the new highest-ranking intent, routing the traffic to each of the one or more remaining receiver nodes via each corresponding tunnel for each remaining reiver node.

As shown at 526, the method may further include transmitting a BGP withdraw to the source node identifying the particular intent to terminate a routing tree involving the particular intent, that is, the previous highest-ranking intent associated with the receiver from which the initial BGP withdraw request was obtained.

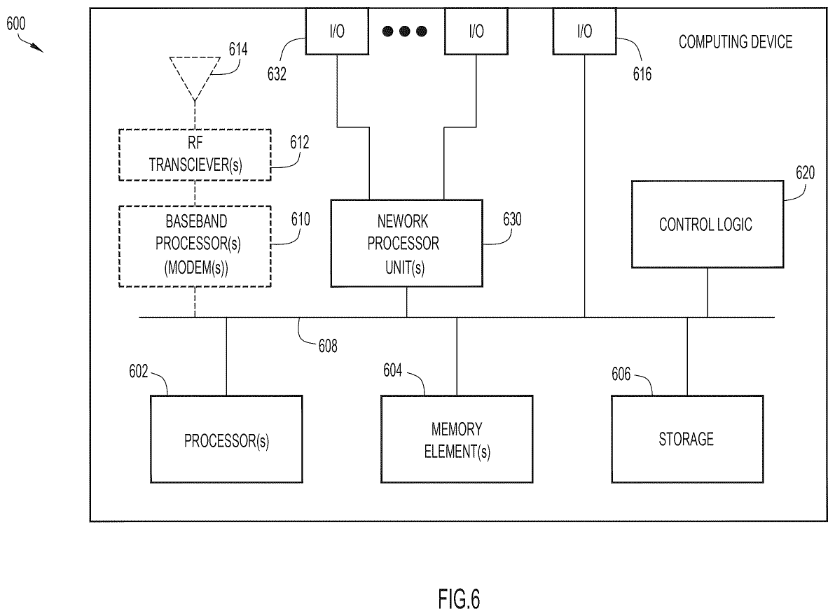

Referring to FIG. 6, FIG. 6 illustrates a hardware block diagram of a computing device 600 that may perform functions associated with operations discussed herein in connection with the techniques described for embodiments herein. In various embodiments, a computing device or apparatus, such as computing device 600 or any combination of computing devices 600, may be configured as any entity/entities in order to perform operations of the various techniques discussed for embodiments herein, such as any elements, functions, etc. discussed for embodiments herein (e.g., a merge point, such as ASBR 204, source 202, receiver 222, receiver 232, and/or receiver 242).

In at least one embodiment, the computing device 600 may be any apparatus that may include one or more processor(s) 602, one or more memory element(s) 604, storage 606, a bus 608, one or more network processor unit(s) 630 interconnected with one or more network input/output (I/O) interface(s) 632, one or more I/O interface(s) 616, and control logic 620. In various embodiments, instructions associated with logic for computing device 600 can overlap in any manner and are not limited to the specific allocation of instructions and/or operations described herein.

In some embodiments, computing device 600 may further include at least one baseband processor or modem 610, one or more radio RF transceiver(s) 612 (e.g., any combination of RF receiver(s) and RF transmitter(s)), one or more antenna(s) or antenna array(s) 614 (which may be inclusive of software-defined antenna(s) or antenna array(s).

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 630 may enable communication between computing device 600 and other systems, entities, etc., via network I/O interface(s) 632 (wired and/or wireless) to facilitate operations discussed for various embodiments described herein. In various embodiments, network processor unit(s) 630 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 632 can be configured as one or more Ethernet port(s), Fibre Channel ports, any other I/O port(s), and/or antenna(s)/antenna array(s) now known or hereafter developed. Thus, the network processor unit(s) 630 and/or network I/O interface(s) 632 may include suitable interfaces for receiving, transmitting, and/or otherwise communicating data and/or information (wired and/or wirelessly) in a network environment.

I/O interface(s) 616 allow for input and output of data and/or information with other entities that may be connected to computing device 600. For example, I/O interface(s) 616 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

If implemented, the RF transceiver(s) 612 may perform RF transmission and RF reception of wireless signals via antenna(s)/antenna array(s) 614, and the baseband processor or modem 610 performs baseband modulation and demodulation, etc. associated with such signals to enable wireless communications for computing device 600.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may be performed by a boundary router that interfaces with a source node of a first service provider and each of a corresponding receiver node of a plurality of receiver nodes of other different service providers. The method may include obtaining (by the boundary router) a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node; identifying a highest-ranking intent from among the plurality of BGP join requests; transmitting another BGP join request to the source node for the multicast group that includes the highest-ranking intent; and upon obtaining traffic from the source node for the multicast group via a tunnel that satisfies the highest-ranking intent, routing the traffic to each corresponding receiver node according to the corresponding intent associated with each corresponding receiver node.

In one instance, the method may include configuring an intent ranking for the boundary router in which an order of the intent ranking is agreed upon by the first service provider and the other different service providers. In one instance, the BGP join request transmitted to the source node further includes a list of other corresponding intents that are not identified as the highest-ranking intent.

In one instance, the method may further include maintaining a multicast routing information base (MRIB) by the boundary router that includes an entry for the multicast group that identifies a tunnel through which traffic is to be received from the source node and identifies each of a corresponding tunnel and the corresponding level of intent associated with each corresponding receiver node.

In one instance, the BGP join request transmitted to the source node further includes a list of one or more lower-ranking intents identified from among the plurality of BGP join requests to cause the source node to store the list of the one or more lower-ranking intents.

In one instance, the method may further include receiving a BGP withdraw request from a particular receiver node of the plurality of receiver nodes for the multicast group, wherein the BGP withdraw request identifies a particular intent associated with the particular receiver node; determining whether the particular intent associated with particular receiver node is the highest-ranking intent; and upon determining that the particular intent is not the highest-ranking intent, terminating a tunnel associated with the particular receiver node to stop routing the traffic to the particular receiver node. In one instance, the method may further include transmitting a BGP attribute update for the multicast group to the source node that includes a particular intent associated with the particular receiver node to cause the source node to remove the particular intent from a list of one or more lower-ranking intents stored by the source node.

In one instance, the method may further include, upon determining that the particular intent is the highest-ranking intent; determining a new highest-ranking intent from among one or more remaining receiver nodes for the multicast group; transmitting a new BGP join request to the source node for the multicast group including at least the new highest-ranking intent; upon obtaining the traffic from the source node for the multicast group via a new tunnel that satisfies the new highest-ranking intent, routing the traffic to each of the one or more remaining receiver nodes via each corresponding tunnel for each remaining reiver node; and transmitting a BGP withdraw to the source node identifying the particular intent to terminate a routing tree involving the particular intent.

In one form, one or more non-transitory computer readable storage media encoded with instructions may be provided that, when executed by a processor, cause the processor to perform operations for a boundary router that interfaces with a source node of a first service provider and each of a corresponding receiver node of a plurality of receiver nodes of other different service providers, the operations comprising: obtaining a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node; identifying a highest-ranking intent from among the plurality of BGP join requests; transmitting another BGP join request to the source node for the multicast group that includes the highest-ranking intent; and upon obtaining traffic from the source node for the multicast group via a tunnel that satisfies the highest-ranking intent, routing the traffic to each corresponding receiver node according to the corresponding intent associated with each corresponding receiver node.

In one form, a network merge point or boundary router may be provided that interfaces with a source node of a first service provider and each of a corresponding receiver node of a plurality of receiver nodes of other different service providers, comprising: at least one memory element for storing data; and at least one processor for executing instructions associated with the data, wherein executing the instructions causes the merge point or boundary router to perform operations, comprising: obtaining a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node; identifying a highest-ranking intent from among the plurality of BGP join requests; transmitting another BGP join request to the source node for the multicast group that includes the highest-ranking intent; and upon obtaining traffic from the source node for the multicast group via a tunnel that satisfies the highest-ranking intent, routing the traffic to each corresponding receiver node according to the corresponding intent associated with each corresponding receiver node.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv 4) and/or IP version 6 (IPv 6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method performed by a boundary router that interfaces with a source node of a first service provider and each of a corresponding receiver node of a plurality of receiver nodes of other different service providers, the method comprising:
obtaining a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node;
identifying a highest-ranking intent from among the plurality of BGP join requests;
transmitting another BGP join request to the source node for the multicast group that includes the highest-ranking intent; and
upon obtaining traffic from the source node for the multicast group via a tunnel that satisfies the highest-ranking intent, routing the traffic to each corresponding receiver node according to the corresponding intent associated with each corresponding receiver node.

2. The method of claim 1, further comprising:
configuring an intent ranking for the boundary router in which an order of the intent ranking is agreed upon by the first service provider and the other different service providers.

3. The method of claim 1, wherein the BGP join request transmitted to the source node further includes a list of other corresponding intents that are not identified as the highest-ranking intent.

4. The method of claim 1, further comprising:
maintaining a multicast routing information base (MRIB) by the boundary router that includes an entry for the multicast group that identifies a tunnel through which traffic is to be received from the source node and identifies each of a corresponding tunnel and the corresponding level of intent associated with each corresponding receiver node.

5. The method of claim 1, wherein the BGP join request transmitted to the source node further includes a list of one or more lower-ranking intents identified from among the plurality of BGP join requests to cause the source node to store the list of the one or more lower-ranking intents.

6. The method of claim 1, further comprising:
receiving a BGP withdraw request from a particular receiver node of the plurality of receiver nodes for the multicast group, wherein the BGP withdraw request identifies a particular intent associated with the particular receiver node;
determining whether the particular intent associated with particular receiver node is the highest-ranking intent; and
upon determining that the particular intent is not the highest-ranking intent, terminating a tunnel associated with the particular receiver node to stop routing the traffic to the particular receiver node.

7. The method of claim 6, further comprising:
transmitting a BGP attribute update for the multicast group to the source node that includes a particular intent associated with the particular receiver node to cause the source node to remove the particular intent from a list of one or more lower-ranking intents stored by the source node.

8. The method of claim 6, further comprising:
upon determining that the particular intent is the highest-ranking intent;
determining a new highest-ranking intent from among one or more remaining receiver nodes for the multicast group;
transmitting a new BGP join request to the source node for the multicast group including at least the new highest-ranking intent;
upon obtaining the traffic from the source node for the multicast group via a new tunnel that satisfies the new highest-ranking intent, routing the traffic to each of the one or more remaining receiver nodes via each corresponding tunnel for each remaining reiver node; and
transmitting a BGP withdraw to the source node identifying the particular intent to terminate a routing tree involving the particular intent.

9. One or more non-transitory computer readable storage media encoded with instructions that, when executed by a processor, cause the processor to perform operations for a boundary router that interfaces with a source node of a first service provider and each of a corresponding receiver node of a plurality of receiver nodes of other different service providers, the operations comprising:
obtaining a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node;
identifying a highest-ranking intent from among the plurality of BGP join requests;
transmitting another BGP join request to the source node for the multicast group that includes the highest-ranking intent; and
upon obtaining traffic from the source node for the multicast group via a tunnel that satisfies the highest-ranking intent, routing the traffic to each corresponding receiver node according to the corresponding intent associated with each corresponding receiver node.

10. The media of claim 9, wherein the instructions, when executed by the processor, cause the processor to perform further operations, comprising:
configuring an intent ranking for the boundary router in which an order of the intent ranking is agreed upon by the first service provider and the other different service providers.

11. The media of claim 9, wherein the BGP join request transmitted to the source node further includes a list of other corresponding intents that are not identified as the highest-ranking intent.

12. The media of claim 9, wherein the instructions, when executed by the processor, cause the processor to perform further operations, comprising:
maintaining a multicast routing information base (MRIB) by the boundary router that includes an entry for the multicast group that identifies a tunnel through which traffic is to be received from the source node and identifies each of a corresponding tunnel and the corresponding level of intent associated with each corresponding receiver node.

13. The media of claim 9, wherein the BGP join request transmitted to the source node further includes a list of one or more lower-ranking intents identified from among the plurality of BGP join requests to cause the source node to store the list of the one or more lower-ranking intents.

14. The media of claim 9, wherein the instructions, when executed by the processor, cause the processor to perform further operations, comprising:
receiving a BGP withdraw request from a particular receiver node of the plurality of receiver nodes for the multicast group, wherein the BGP withdraw request identifies a particular intent associated with the particular receiver node;
determining whether the particular intent associated with particular receiver node is the highest-ranking intent; and
upon determining that the particular intent is not the highest-ranking intent, terminating a tunnel associated with the particular receiver node to stop routing the traffic to the particular receiver node.

15. The media of claim 14, wherein the instructions, when executed by the processor, cause the processor to perform further operations, comprising:
upon determining that the particular intent is the highest-ranking intent;
determining a new highest-ranking intent from among one or more remaining receiver nodes for the multicast group;
transmitting a new BGP join request to the source node for the multicast group including at least the new highest-ranking intent;
upon obtaining the traffic from the source node for the multicast group via a new tunnel that satisfies the new highest-ranking intent, routing the traffic to each of the one or more remaining receiver nodes via each corresponding tunnel for each remaining reiver node; and
transmitting a BGP withdraw to the source node identifying the particular intent to terminate a routing tree involving the particular intent.

16. A boundary router that interfaces with a source node of a first service provider and each of a corresponding receiver node of a plurality of receiver nodes of other different service providers, comprising:
at least one memory element for storing data; and
at least one processor for executing instructions associated with the data, wherein executing the instructions causes the boundary router to perform operations, comprising:
obtaining a plurality of Border Gateway Protocol (BGP) join requests, each BGP join request of the plurality of BGP join requests being obtained from a corresponding receiver node of the plurality of receiver nodes requesting to join a multicast group and receive traffic provided by the source node, wherein each BGP join request identifies a corresponding intent representing a corresponding level of service for routing the traffic to each corresponding receiver node;
identifying a highest-ranking intent from among the plurality of BGP join requests;
transmitting another BGP join request to the source node for the multicast group that includes the highest-ranking intent; and
upon obtaining traffic from the source node for the multicast group via a tunnel that satisfies the highest-ranking intent, routing the traffic to each corresponding receiver node according to the corresponding intent associated with each corresponding receiver node.

17. The boundary router of claim 16, wherein an intent ranking is configured for the boundary router in which an order of the intent ranking is agreed upon by the first service provider and the other different service providers.

18. The boundary router of claim 16, wherein the BGP join request transmitted to the source node further includes a list of other corresponding intents that are not identified as the highest-ranking intent.

19. The boundary router of claim 16, wherein executing the instructions causes the boundary router to perform further operations, comprising:
maintaining a multicast routing information base (MRIB) by the boundary router that includes an entry for the multicast group that identifies a tunnel through which traffic is to be received from the source node and identifies each of a corresponding tunnel and the corresponding level of intent associated with each corresponding receiver node.

20. The boundary router of claim 16, wherein the BGP join request transmitted to the source node further includes a list of one or more lower-ranking intents identified from among the plurality of BGP join requests to cause the source node to store the list of the one or more lower-ranking intents.
